(19) United States
(12) Patent Application Publication
(10) Pub. No.: US 2007/0226383 A1
(43) Pub. Date: Sep. 27, 2007

(54) TOUCH SENSING APPARATUS

(75) Inventors: Shin-Hong Chung, Shenzhen (CN); Han-Che Wang, Shenzhen (CN); Shi-Quan Lin, Shenzhen (CN); Kuan-Hong Hsieh, Shenzhen (CN); Xin Zhao, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/616,887

(22) Filed: Dec. 28, 2006

(30) Foreign Application Priority Data
Feb. 17, 2006 (CN) 200610033835.2

(51) Int. Cl. G06F 3/00

(52) U.S. Cl. 710/29

(57) ABSTRACT

A touch sensing apparatus is provided. A preferred embodiment of a touch sensing apparatus includes a sensor (13), an MCU (15), and an integration circuit (14). The sensor is for receiving electricity signals from an object that touches the sensor. The MCU (Microcontrol Unit) has a signal output port A and a signal input port B. The signal input port is connected to the sensor. The integration circuit interposes between the signal output port and the signal input port of the MCU. The signal output port outputs AC signals to the signal input port through the integration circuit. The integration circuit prolongs active transition times of the AC signals, and the MCU identifies a touch on the sensor when the active transition times of the AC signals fall in a predetermined range and accordingly implements a predetermined function.

### BACKGROUND OF THE INVENTION

1. Field of the Invention

The present invention relates generally to touch sensing apparatuses, and particularly to a touch sensing apparatus for sensing electrical signals of an object.

2. Description of Related Art

There are several available types of touch-sensing devices that may be employed for use as positional indicators in apparatuses such as personal computers. Among them, resistive-membrane positioning sensors and capacitive positioning sensors are well known and typically used in several applications. However, the resistive-membrane positioning sensors generally have poor resolutions. In addition, surfaces of the resistive-membrane positioning sensors are often exposed to air, and are therefore easily worn out. Furthermore, resistive-membrane positioning sensors are relatively expensive.

A capacitive positioning sensor typically includes a substrate which supports a first and second interleaved, closely spaced, non-overlapping arrays of conductive plates. An insulating layer overlies the first and second arrays. When an outer surface of the insulating layer is touched, the capacitances of at least one of the columns of plates of the first array and one of the rows of plates of the second array underlying the insulating layer at a location being touched exhibits a change with respect to ambient ground. Based upon the measured capacitance of each column of the first array and row of the second array, a microcomputer produces output signals representing the coordinates of the location being touched. These output signals can be used, for example, to control a position of a cursor on a display screen of a personal computer or to make a selected function command. Although the capacitive positioning sensor has been designed to avoid being exposed in air and thereby to avoid being easily worn out, however, by overlying the insulating layer thereon, the sensitivity of the touch sensing apparatus is reduced.

What is still needed is a touch sensing apparatus with reduced circuitry complexity, improved sense sensitivity, improved efficiency, and lower manufacturing costs.

### SUMMARY OF THE INVENTION

A touch sensing apparatus is provided. A preferred embodiment of a touch sensing apparatus includes a sensor, an MCU, and an integration circuit. The sensor is for receiving electricity signals from an object that touches the sensor. The MCU (Microcontrol Unit) has a signal output port and a signal input port. The signal input port is connected to the sensor. The integration circuit interposes between the signal output port and the signal input port of the MCU. The signal output port outputs AC signals to the signal input port through the integration circuit. The integration circuit prolongs active transition times of the AC signals, and the MCU identifies a touch on the sensor when the active transition times of the AC signals fall in a predetermined range and accordingly implements a predetermined function.

Other advantages and novel features will be drawn from the following detailed description of the preferred embodiment with reference to the attached drawings, in which:

### BRIEF DESCRIPTION OF THE DRAWINGS

FIG. 1 is an exemplary circuit diagram of a touch sensing apparatus in accordance with a preferred embodiment of the present invention.

### DETAILED DESCRIPTION OF THE INVENTION

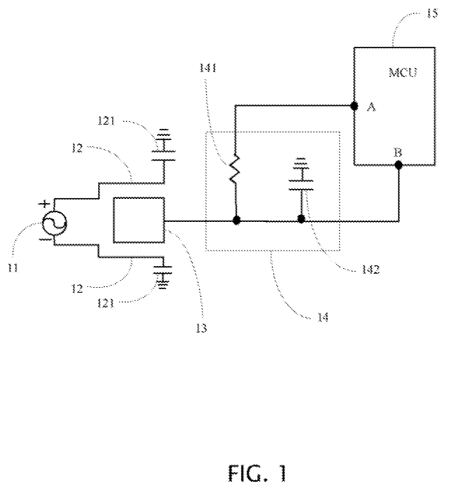

FIG. 1 is an exemplary circuit diagram of a touch sensing apparatus in accordance with a preferred embodiment of the present invention. The apparatus mainly includes a differential signal source 11, two conductors 12, two capacitors 121, a sensor 13, an integration circuit 14, and a microcontroller unit (MCU) 15.

The differential signal source 11 has a positive output and a negative output, each connecting to ground via one of the conductors 12 and one of the capacitors 121 correspondingly. The sensor 13 is located between the conductors 12, and forms two parallel-arranged capacitors with the conductors 12.

The differential signal source 111 outputs a positive signal and a negative signal via the positive output and the negative output respectively. Generally, environmental noises are generated in an environment with charged bodies such as electric lights and computers. The environmental noises are AC signals with irregular waveforms. When the environmental noises reach the parallel-arranged capacitors, positive half-waves and negative half-waves of the environmental noise are offset by the positive signal and the negative signal outputted by the differential signal source 11 respectively. The touch sensing apparatus is therefore protected from disturbances caused by the environmental noises and improves a sensitivity of the touch sensing apparatus. Furthermore, when the circuit is placed in an environment with high-intensity environment noises, such as in a high cell phone signal environment, only the parallel-arranged capacitors cannot offset the high-intensity environment noises. The capacitor 121 is therefore provided to further offset the high-intensity environment noise.

The MCU 15 includes a signal output port A and a signal input port B. The signal input port B is connected with the sensor 13 via the integration circuit 14. The integration circuit 14 is composed of a resistor 141 and a capacitor 142. The resistor 141 of the integration circuit 14 is interposed between the signal output port A and the signal input port B of the MCU 15 while the capacitor 142 of the integration circuit 14 is interposed between the signal input port B and ground. The signal output port A is for providing AC signals with a predetermined frequency and phase. The AC signals pass though the integration circuit 14 and are inputted to the signal input port B of the MCU 15. The integration circuit 14 prolongs an active transition time of the AC signal between a logic high level signal and a logic low level signal.

Generally, charged bodies can create alternating magnetic fields around themselves. When an electrical conducting object such as a human body moves into the alternating magnetic field, inductive charges are generated and distributed on surfaces of the electrical conducting object, thus, improving electrical signals of the electrical conducting object. In the preferred embodiment, the differential signal source 11 provides the alternating magnetic field, thus improving the electrical signals of the electrical conducting object that touches the sensor 13.

The sensor 13 and ground form a distributed capacitor. When the electrical conducting object touches the sensor 13, the inductive charges on the electrical conducting object flows to the sensor 13, thus causing a capacitance change of the distributed capacitor that further causes a capacitance change to the integration circuit 14. The integration circuit 14 further prolongs the active transition time of the AC signals. Therefore, the active transition time of the AC signals inputted to the signal input port A (hereafter “input signals”) when the sensor is touched is greater than the active transition time of the AC signals inputted to the signal input port A when the sensor is not touched. The MCU 15 detects a change of the active transition time of the input signals at every predetermined time. If the active transition time of the input signals are prolonged, the MCU 15 confirms that the sensor 13 is touched and implements a predetermined function.

In applications, “spurious touches” may exist and disturb the MCU 15 to accurately identify the real touches on the sensor 13. The “spurious touches” are produced when, for example when the apparatus is taken from a relative low-intensity environment noise environment to a relative high-intensity environment noise environment, or when the environment noise of the environment the apparatus is placed in increases. The increase of the environment noise prolongs active transition time of the input signals and therefore disturbs the MCU 15. To prevent the disturbance to the MCU 15 from the “spurious touches”, two time values Ts1 and Ts2, respectively representing the active transition time when the sensor 13 is not being touch and when the sensor 13 is being touched, may be predetermined and stored in the MCU 15. Ts1 and Ts2 may be determined and recorded by placing the apparatus in an environment with feasible highest environment noise.

Thereby, in a common environment, when the MCU 15 detects that the active transition time of the input signals of the MCU 15 falls between Ts1 and Ts2, the MCU 15 confirms that the sensor is touched and then implements the predetermined function. Additionally, a preset time can also be stored in the MCU 15 and used by the MCU 15 to further identify a real touch from the “spurious touches” when the active transition time of the input signal falls between Ts1 and Ts2. The MCU 15 determines whether a continuous time when the active transition time of the input signal falls between Ts1 and Ts2 is less than the predetermined time. If the continuous time is less than the predetermined time, the MCU 15 derives that a “spurious touch” takes place and ignores the “spurious touch”. If the continue time is equal to or greater than the predetermined time, the MCU 15 derives that a real touch takes place and implement the predetermined function.

What is claimed is:

1. A touch sensing apparatus comprising:
a sensor for receiving electricity signals from an object that touches the sensor;
an MCU (Microcontrol Unit) having a signal output port and a signal input port, the signal input port being connected to the sensor; and
an integration circuit interposed between the signal output port and the signal input port of the MCU;
wherein, the signal output port outputs AC signals to the signal input port through the integration circuit, the integration circuit prolongs active transition times of the AC signals, and the MCU identifies a touch on the sensor when the active transition times of the AC signals fall in a predetermined range and accordingly implements a predetermined function.

2. The touch sensing apparatus as described in claim 1, further comprising a differential signal source configured for generating a positive signal and a negative signal.

3. The touch sensing apparatus as described in claim 2, further comprising two conductors respectively connected to the positive signal output and the negative signal output of the differential signal source.

4. The touch sensing apparatus as described in claim 3, wherein the sensor locates between the two conductors and forms two parallel-connected capacitors with the two conductors for offsetting environmental noise.

5. The touch sensing apparatus as described in claim 4, wherein each conductor further connects a capacitor for offsetting high-intensity environment noise.

6. The touch sensing apparatus as described in claim 4, wherein the MCU stores a value of a predetermined time, and implements the predetermined function when a continue time during which the active transition times of the AC signals falls in the predetermined range is equal to or greater than the value of the predetermined time.
